(19) United States
(12) Patent Application Publication
(10) Pub. No.: US 2005/0257545 A1
(43) Pub. Date: Nov. 24, 2005

(54) Dual compressor HVAC system

(76) Inventors: Lawrence P. Ziehr, Clarkston, MI (US); Gregory A. Major, Farmington Hills, MI (US); Mark D. Nemesh, Troy, MI (US)

Correspondence Address: LAURA C. HARGITT;General Motors Corporation, Mail Code 482-C23-B21, P.O. Box 300, Detroit, MI, 48265-3000, US

(21) Appl. No.: 10/852,559

(22) Filed: May 24, 2004

(51) Int. Cl. F25B 43/00; B60H 1/32; F25B 43/02; F25B 27/00

(52) U.S. Cl. 62/236; 62/244; 62/512

(57) ABSTRACT

The present invention concerns an automotive HVAC system for use in a vehicle having a vehicle body that includes an engine and a battery. The HVAC system has a predetermined design cooling capacity and includes a condenser and one of an orifice tube and an expansion valve in fluid communication with the condenser. A first compressor is adapted to be mechanically driven by the engine and is in fluid communication from the evaporator and in fluid communication to the condenser. A second compressor is electrically connected to and driven by the battery bank and is in fluid communication from the evaporator and in fluid communication to the condenser. Each of the compressors is selectively operable to compress refrigerant in the HVAC system during operation of the HVAC system.

### BACKGROUND OF THE INVENTION

The present invention relates generally to automotive heating, ventilation, and air conditioning (HVAC) systems and methods of operating such HVAC systems.

Hybrid vehicles, which utilize an internal combustion engine and a battery-powered electric motor for vehicle movement, are becoming more and more popular because of their increased fuel efficiency as compared to those vehicles having only an internal combustion engine. In a typical hybrid vehicle control, the engine is utilized in higher power requirement situations and the motor is utilized during starting, braking, and in lower power requirement situations.

Hybrid vehicles, in particular, have had concerns because of the need to provide cooling when the engine is not running in warmer ambient conditions. HVAC compressors are typically driven by the engine through a clutch or the like and, therefore, do not function when the vehicle engine is not running. With the engine and compressor off, the interior of the vehicle may heat up quickly, disadvantageously requiring the engine to be operated solely for the purpose of providing cooling to the occupants of the vehicle.

It is desirable, therefore, to provide a HVAC system that allows the engine in a hybrid vehicle to remain off while still keeping the occupants of the vehicle cool and comfortable. It is also desirable to provide a HVAC system that allows for greater flexibility and efficiency of operation, regardless of the type of vehicle.

### SUMMARY OF THE INVENTION

The present invention concerns an automotive HVAC system for use in a vehicle having a vehicle body that includes an engine and a battery. The HVAC system has a predetermined design cooling capacity and includes a condenser and one of an orifice tube and an expansion valve in fluid communication with the condenser. A first compressor is adapted to be mechanically driven by the engine and is in fluid communication from the evaporator and in fluid communication to the condenser. A second compressor is electrically connected to and driven by the battery bank and is in fluid communication from the evaporator and in fluid communication to the condenser. Each of the compressors is selectively operable to compress refrigerant in the HVAC system during operation of the HVAC system.

The first and second compressors may be in fluid communication with the condenser in a parallel configuration wherein the first compressor and the second compressor each have a distinct suction line in fluid communication with the evaporator. In the parallel configuration, the first and second compressors discharge into a common discharge line that is in fluid communication with the condenser. Alternatively, the first and second compressors may be in fluid communication with the condenser in a series configuration wherein the first compressor discharges into the suction of the second compressor and the second compressor discharges to the condenser. Regardless of the series or parallel configuration, each of the compressors may be operated individually.

Each of the compressors has a pumping or cooling capacity equal to a predetermined value and the HVAC system has a design cooling capacity equal to a predetermined value. The respective values of the pumping or cooling capacity of the compressors may vary depending on the cooling capacity requirements of the HVAC system and the packaging requirements of the vehicle body.

The electric-drive compressor allows for extended hybrid engine off operation of the vehicle while maintaining A/C comfort and enables vehicle preconditioning, wherein the electric-drive compressor runs to cool the passenger compartment prior to occupant entry. The cooling capacities of the compressors may be advantageously sized so that the operation of the HVAC system is more efficient than using a single large electric-drive or mechanical-drive compressor because each of the compressors of the present invention may be sized smaller to operate during less demand and thus consume less energy.

The HVAC system in accordance with the present invention provides greater vehicle packaging flexibility because a smaller electric-drive compressor can be located on or off the vehicle engine. In contrast, a dual-drive compressor is a larger package that must be on the engine and a single larger electric-drive compressor is more difficult to locate in the vehicle engine compartment.

The HVAC system in accordance with the present invention is well suited for use in hybrid vehicles. The HVAC system, however, may also be advantageously utilized in standard or conventional vehicles having only internal combustion engines wherein the second electric compressor runs when the cooling demand is reduced or lowered, which eliminates the parasitic load of the engine-driven compressor and increases the overall fuel efficiency of the vehicle.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic view of a HVAC system in accordance with the present invention;

FIG. 2 is a schematic view of an alternative embodiment of a HVAC system in accordance with the present invention; and

FIG. 3 is a block diagram of a HVAC system in accordance with the present invention.

### DESCRIPTION OF THE PREFERRED EMBODIMENT

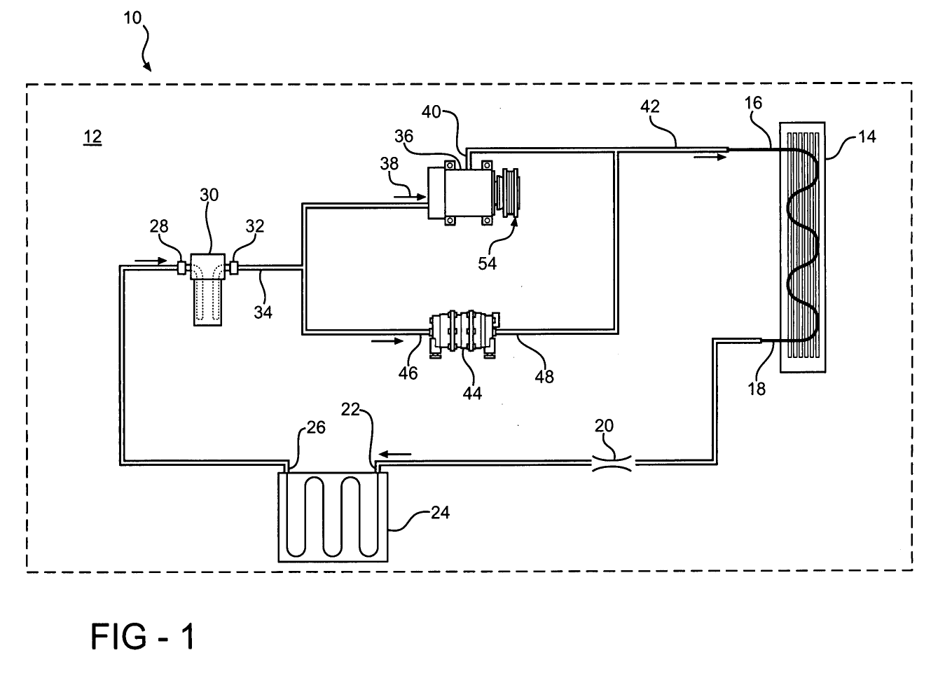

Referring now to FIG. 1, an HVAC system in accordance with the present invention is indicated generally at 10. The HVAC system 10 is disposed in a vehicle having a vehicle body, indicated schematically at 12. The HVAC system 10 includes a condenser 14 having an inlet 16 and an outlet 18. The condenser 14 includes a plurality of fins (not shown) or the like for transferring heat to ambient air or the like. The outlet 18 of the condenser 14 is in fluid communication with an orifice tube 20. Alternatively, the orifice tube 20 is replaced with a thermostatic expansion valve (not shown) or the like. The orifice tube 20 is also in fluid communication with an inlet 22 of an evaporator 24. The evaporator 22 is preferably disposed in a HVAC air duct (not shown) or the like for absorbing heat from an air stream flowing therethrough. An outlet 26 of the evaporator 24 is in fluid communication with an inlet 28 of an accumulator 30. An outlet 32 of the accumulator 30 is in fluid communication with a compressor suction conduit 34.

A first compressor 36 has an inlet 38 in fluid communication with the compressor suction conduit 34 and an outlet 40 in fluid communication with a compressor discharge conduit 42. The compressor discharge conduit 42 is in fluid communication with the inlet 16 of the condenser 14. The first compressor 36 is adapted to be driven by an engine (not shown) of the vehicle, such as by a belt and pulley assembly driven by a crankshaft (not shown) or the like. The first compressor 36 may be a fixed or variable displacement compressor, as will be appreciated by those skilled in the art and may also be engaged and disengaged from the engine by a clutch 54, if desired. A second compressor 44 has an inlet 46 in fluid communication with the compressor suction conduit 34 and an outlet 48 in fluid communication with the compressor discharge conduit 42. The second compressor 44 includes a motor that is electrically connected to and driven by a battery bank (not shown) disposed in the vehicle. The second compressor 44 may be a fixed or variable displacement compressor, as will be appreciated by those skilled in the art.

Each of the compressors 36 and 44 has a pumping or cooling capacity equal to a predetermined value and the HVAC system 10 has a design cooling capacity equal to a predetermined value. The respective values of the pumping or cooling capacity of the compressors 36 and 44 may vary depending on the cooling capacity requirements of the HVAC system 10. For example, the first compressor 36 may have a maximum capacity equal to the design cooling capacity of the HVAC system 10 and the second compressor 44 may have a maximum capacity less than the design cooling capacity of the HVAC system 10. Similarly, the maximum capacity of the first compressor 36 and the maximum capacity of the second compressor 44 may each be a predetermined percentage of the design cooling capacity of the HVAC system 10 wherein, for example, the maximum capacity of the first compressor 36 and the maximum capacity of the second compressor 44 equal, in sum, the design cooling capacity of the HVAC system 10. Those skilled in the art will appreciate that the respective capacities of the first compressor 36 and the second compressor 44 may vary, depending on the specific design requirements and/or packaging restrictions of the vehicle body 12 and the HVAC system 10, while remaining within the scope of the present invention.

In FIG. 1, the first compressor 36 and the second compressor 44 are piped in a parallel configuration, wherein each of the compressors 36 and 44 are in distinct fluid communication with the both the compressor suction conduit 34 and the compressor discharge conduit 42. Specifically, the inlet 38 of the first compressor 36 is in fluid communication only with the compressor suction conduit 34 and the inlet 46 of the second compressor 44 is in fluid communication only with the compressor suction conduit 34. The outlet 40 of the first compressor 36 is in fluid communication only with the compressor discharge conduit 42 and the outlet 48 of the second compressor 44 is in fluid communication only with the compressor discharge conduit 42. The compressors 36 and 44 are each operable to compress the refrigerant contained in the piping of the HVAC system 10 to provide cooled air to the interior of the vehicle body 12. If the compressors 36 and 44 in the parallel configuration of FIG. 1 are operated concurrently or separately, each compressor 36 and 44 receives refrigerant from the compressor suction conduit 34 and discharges pressurized refrigerant to the compressor discharge conduit 42 during operation of the HVAC system 10.

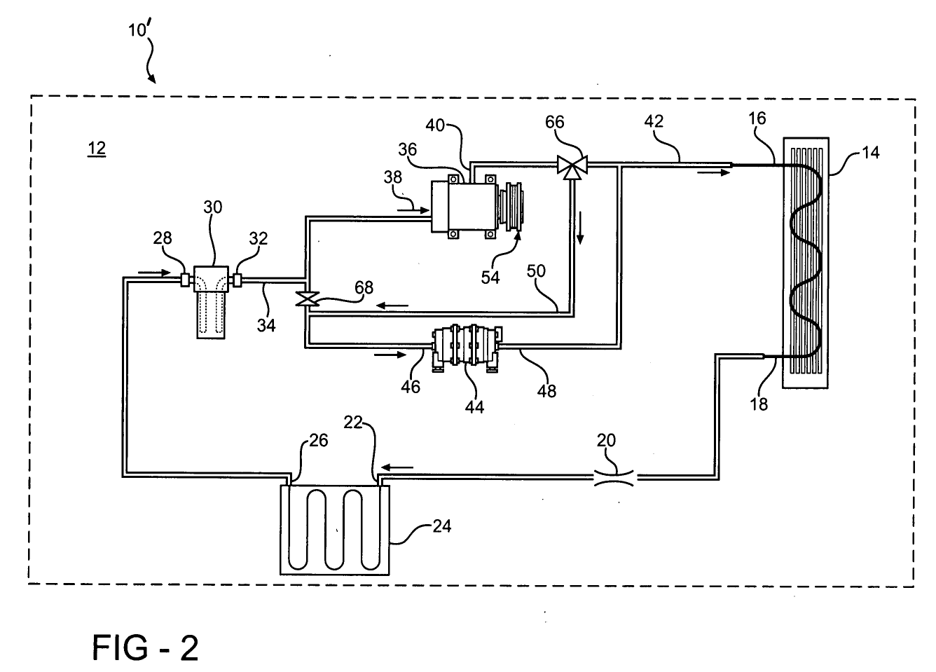

Referring now to FIG. 2, an alternative embodiment of a HVAC system is indicated generally at 10′. Like elements from FIG. 1 are shown in FIG. 2 with the same reference numerals for clarity. In FIG. 2, the first compressor 36 and the second compressor 44 are piped in a series configuration, wherein the HVAC system 10′ includes a series conduit 50 that allows for fluid flow from the outlet 40 of the first compressor 36 to the inlet 46 of the second compressor 44. As in the parallel configuration of FIG. 1, the compressors 36 and 44 are each operable to compress the refrigerant contained in the piping of the HVAC system 10′ to provide cooled air to the interior of the vehicle body 12. If the compressors 36 and 44 in the series configuration of FIG. 2 are operated concurrently, refrigerant flows from the compressor suction conduit 34 into the inlet 38 of the first compressor 36 to the outlet 40 of the first compressor 38, through the series conduit 50 into the inlet of the second compressor 44 and from the outlet 48 of the second compressor 36 to the compressor discharge conduit 42. Alternatively, the flow of the refrigerant in the series configuration of FIG. 2 could be reversed (not shown) and the series conduit 50 rerouted such that the series conduit 50 allows for fluid flow from the outlet 48 of the second compressor 44 to the inlet 38 of the first compressor, without departing from the scope of the present invention. If the compressors 36 and 44 in the series configuration of FIG. 2 are operated separately, the refrigerant flows from the compressor suction conduit 34 into the inlet 38 of the first compressor 36 or the inlet 46 of the second compressor 44 and from the outlet 40 of the first compressor 36 or the outlet 48 of the second compressor 44 to the compressor discharge conduit 42.

At least a first valve 66 is disposed adjacent the outlet 40 of the first compressor 36, and at least a second valve 68 is disposed adjacent the inlet 46 of the second compressor 44. The first valve 66 is preferably a three-way valve that selectively allows flow from the outlet 40 of the first compressor 36 to either the series conduit 50 or the compressor discharge conduit 42. The second valve 68 allows flow to the inlet 46 of the second compressor 44 from the compressor suction conduit 34 when open and from the series conduit 50 when closed. Other valves (not shown) such as stop valves, check valves, and the like may be disposed in appropriate locations such as adjacent the respective inlets 38 and 46 and outlets 40 and 48 of the compressors 36 and 44 as well as in the series conduit 50, the compressor suction conduit 34, and the compressor discharge conduit 42. These valves and the valves 66 and 68 allow the compressors 36 and 44 to be isolated from one another and from the other components of the HVAC system 10′ during dual or single compressor operation.

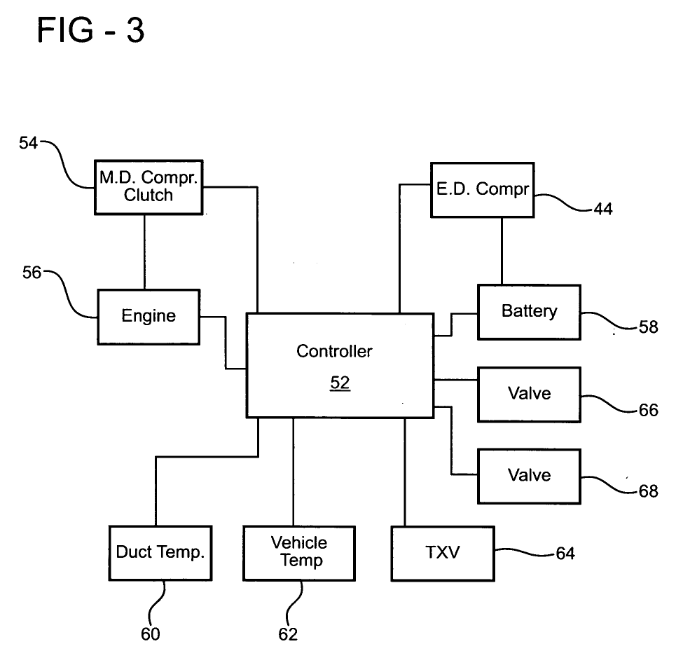

Referring now to FIG. 3, the HVAC system 10 or 10′ includes a controller 52 electrically connected to and operatively engaging the clutch 54 of the first compressor 36, the motor of the second compressor 44, a vehicle engine 56, a vehicle battery pack 58, a first temperature measurement device 60, a second temperature measurement device 62, a thermostatic expansion valve 64, the first valve 66, and the second valve 68. Preferably, the first temperature measurement device 60 is a HVAC duct temperature measurement device, and the second temperature measurement device 62 is a passenger compartment temperature measurement device. The first compressor 36 is connected to and driven by the vehicle engine 56 through the clutch 54 and the motor of the second compressor 44 is connected to and driven by the vehicle battery pack 58. Alternatively, the first compressor 36 is a variable displacement compressor that is driven by the engine 54 but does not include a clutch and the controller 52 directly engages the first compressor 36. Alternatively, the thermostatic expansion valve 64 is replaced with a orifice tube (not shown), such as the orifice tube 20 of FIGS. 1 and 2, or any other type of refrigerant expander. The controller 52 is preferably an electronic control unit, such as an HVAC control unit or the like. The controller 52 may be a single microprocessor or a plurality of interconnected microprocessors. For example, the controller 52 may be a HVAC controller in communication with a powertrain controller or a single integrated HVAC and powertrain controller. Furthermore, the controller 52 may be hardware, software, or any combination thereof as will be appreciated by those skilled in the art. The controller 52 is operable to receive signals, such as from the measurement devices 60, 62, and 64 and to transmit commands, such as to the clutch 54, the compressor 44, and the valves 66 and 68 during operation of the HVAC system 10 or 10′.

In operation, the HVAC system 10 or 10′ is engaged and compressors 36 or 44 are operated to compress refrigerant contained in the piping of the HVAC system 10 or 10′ to provide cooled air to the interior of the vehicle body 12. During operation of the HVAC system 10 or 10′, the controller 52 monitors the temperature in the interior of the vehicle body 12, and the output and condition of the compressors 36 or 44. Typically, the controller 52 will include stored values corresponding to the design cooling capacity of the HVAC system 10 or 10′, and the respective cooling capacities of the compressors 36 and 44. The controller 52 will also calculate the current cooling demand requirements of the HVAC system 10 or 10′ based on, for example, temperatures measured by the temperature measurement devices 60 and 62 or the like and the settings of the HVAC system 10 or 10′ by the vehicle occupants. Depending on the calculated cooling demand, and the respective cooling capacities of the compressors 36 and 44, the controller 52 engages the first compressor 36, the second compressor 44, or both the first compressor 36 and the second compressor 44 to provide cooled air to the interior of the vehicle body 12. In addition, if the compressors 36 or 44 are variable displacement compressors, the controller 52 may vary the displacement of the compressors 36 or 44, depending on the calculated cooling demand. Moreover, depending on the configuration of the HVAC system 10 or 10′, the controller 52 will also open or close the necessary valves 66 and/or 68 when engaging the compressors 36 and/or 44.

For example, the vehicle may be a hybrid vehicle that utilizes an internal combustion engine, such as the engine 56 of FIG. 3, and an electric motor (not shown) powered by a battery, such as the battery pack 58 of FIG. 3 for vehicle movement. If the vehicle is a hybrid vehicle, when the engine 56 is turned off, the first compressor 36 is also turned off and the controller 52 operates only the second compressor 44, depending on the calculated cooling demand of the HVAC system 10 or 10′. The controller 52 operates the second compressor 44 while also monitoring the stored voltage available in the vehicle battery pack 58 and/or the power consumption of the second compressor 44. If the second compressor 44 is a variable displacement compressor, the controller 52 varies the displacement of the compressor 44 in response to the calculated cooling demand, which can reduce the load on the vehicle battery pack 58. If the stored voltage, state charge, or reserve power supply in the vehicle battery pack 58 drops below a predetermined value, or the power consumption of the compressor 44 exceeds a predetermined value, the controller 52 restarts the engine 56 and engages the first compressor 36 to provide cooling for the interior of the vehicle body 12.

The vehicle may also be a standard vehicle that utilizes an internal combustion engine, such as the engine 56 of FIG. 3, for vehicle movement and a battery, such as the battery pack 58 of FIG. 3, for starting the engine and operating other vehicular electrical components. In this case, the controller 52 operates either the first compressor 36 or the second compressor 44, depending on the cooling capacity of the compressors 36 and 44 and on the calculated cooling demand of the HVAC system 10 or 10′. For example, if the compressor 44 has a lower cooling capacity than the compressor 36, the compressor 44 may be operated when the calculated cooling demand is below a predetermined value or vice versa, which is based on the operational efficiency of the system 10. In the standard vehicle, operating only the compressor 44 will reduce the parasitic load of the first compressor 36 on the engine 56, resulting in a more efficient engine operation and potential increased fuel economy.

Depending on the type of vehicle and the current operating conditions, the controller 52 monitors temperatures, calculates cooling demand, and operates the compressors 36 and 44 in a manner that will meet the cooling demand calculated by the controller 52 in the most efficient manner.

In accordance with the provisions of the patent statutes, the present invention has been described in what is considered to represent its preferred embodiment. However, it should be noted that the invention can be practiced otherwise than as specifically illustrated and described without departing from its spirit or scope.

1. An automotive HVAC system for use in a vehicle having a vehicle body, the vehicle body including an engine and a battery, the HVAC system having a predetermined design cooling capacity, comprising:
a condenser;
one of an orifice tube and an expansion valve in fluid communication with said condenser;
an evaporator in fluid communication with the one of an orifice tube and an expansion valve and being disposed in the vehicle body;
a first compressor adapted to be mechanically driven by said engine and in fluid communication from said evaporator and in fluid communication to said condenser; and
a second compressor electrically connected to and driven by said battery, and in fluid communication from said evaporator and in fluid communication to said condenser,
whereby each of said compressors is selectively operable to compress refrigerant in said HVAC system during operation of said HVAC system.

2. The apparatus according to claim 1 including a controller operable to control said first and second compressors and to selectively cause said first and second compressors to operate simultaneously.

3. The HVAC system according to claim 1 including a controller operable to control the operation of said first and second compressors.

4. The HVAC system according to claim 3 including an air duct temperature sensor, a vehicle interior temperature sensor and wherein said controller is electrically connected to said air duct temperature sensor, said vehicle interior temperature sensor, the one of the orifice tube and the thermostatic expansion valve, said engine and said battery.

5. The HVAC system according to claim 4 wherein said controller calculates a cooling demand based on a measurement from at least one of said air duct temperature sensor and said vehicle interior temperature sensor.

6. The HVAC system according to claim 1 wherein said first and second compressor are parallel connected and operable simultaneously.

7. The HVAC system according to claim 1 wherein said first and second compressors are series connected.

8. The HVAC system according to claim 1 wherein said first compressor has a cooling capacity equal to said predetermined design cooling capacity of said HVAC system and said second compressor has a cooling capacity less than said predetermined design cooling capacity of said HVAC system.

9. The HVAC system according to claim 1 wherein said first and second compressors have a combined cooling capacity equal to said predetermined design cooling capacity of said HVAC system.

10. The HVAC system according to claim 1 further including a controller operable to automatically control the operation of said first and second compressors such that said second compressor runs and said first compressor is off when a cooling demand is below a predetermined value and said first and second compressors each run when the cooling demand is above a predetermined value.

11. The HVAC system according to claim 1 wherein said second compressor runs only when said battery has a reserve power supply greater than a predetermined value.

12. The HVAC system according to claim 1 wherein said first compressor is connected to said engine by a clutch.

13. An automotive HVAC system, the HVAC system including at least an accumulator, a condenser, a refrigerant expander, and an evaporator disposed in a vehicle body, the vehicle body include an engine and a battery bank, the HVAC system having a predetermined design cooling capacity, comprising:
a first compressor coupled to and selectively driven by said engine;
a second compressor electrically connected to and selectively driven by said battery bank, each of said compressors connected to a refrigerant supply between said accumulator and said condenser; and
a controller in communication with said first and second compressors, said engine, and said battery bank,
whereby said controller is operable to control the operation of each of said compressors to provide compressed refrigerant to said HVAC system during operation of said HVAC system.

14. The HVAC system according lo claim 13 wherein said controller is electrically connected to an air duct temperature sensor, a vehicle interior temperature sensor, and said refrigerant expander.

15. The HVAC system according to claim 14 wherein said controller calculates a cooling demand based on a measurement from at least one of said air duct temperature sensor and said vehicle interior temperature sensor.

16. The HVAC system according to claim 13 wherein said first and second compressor are parallel connected.

17. The HVAC system according to claim 13 wherein said first and second compressors are series connected.

18. The HVAC system according to claim 13 wherein said first compressor has a cooling capacity equal to said predetermined design cooling capacity of said HVAC system and said second compressor has a cooling capacity less than said predetermined design cooling capacity of said HVAC system.

19. The HVAC system according to claim 13 wherein said first and second compressors have a combined cooling capacity equal to said predetermined design cooling capacity of said HVAC system.

20. The HVAC system according to claim 13 wherein said second compressor runs only when said battery pack has a reserve power supply greater than a predetermined value.
